(19) United States
(12) Patent Application Publication
(10) Pub. No.: US 2011/0101893 A1
(43) Pub. Date: May 5, 2011

(54) Accelerator for Accelerating Charged Particles and Method for Operating an Accelerator

(76) Inventor: Oliver Heid, Erlangen (DE)

(21) Appl. No.: 13/002,357

(22) PCT Filed: May 19, 2009
(86) PCT No.: PCT/EP2009/056079

§ 371 Date: Jan. 3, 2011

(30) Foreign Application Priority Data
Jul. 4, 2008 (DE) 10 2008 031 634.2

(51) Int. Cl. H05H 9/00

(52) U.S. Cl. 315/505

(57) ABSTRACT

An accelerator for accelerating charged particles has at least two delay lines having different delays, wherein the at least two delay lines have an input side into which electromagnetic waves can be conducted for producing an accelerating electric potential, wherein the input side of the delay lines is designed to reflect electromagnetic waves, and the accelerating electric potential can be produced at least partially by the waves reflected at the input side. In a method for operating an accelerator, which comprises at least two delay lines having different delays, the at least two delay lines have an input side into which electromagnetic waves can be conducted for producing an accelerating electric potential, wherein the electromagnetic waves conducted into the delay lines are reflected at the input side, and the accelerating electric potential can be produced at least partially by the waves reflected at the input side.

### CROSS-REFERENCE TO RELATED APPLICATIONS

This application is a U.S. National Stage Application of International Application No. PCT/EP2009/056079 filed May 19, 2009, which designates the United States of America, and claims priority to DE Application No. 10 2008 031 634.2 filed Jul. 4, 2008. The contents of which are hereby incorporated by reference in their entirety.

### TECHNICAL FIELD

The invention relates to an accelerator for accelerating charged particles and to a method for operating an accelerator of said type. An accelerator of said type can be used inter alia in medical engineering, in particular in the context of radiation therapy, where it is necessary to accelerate charged particles such as e.g. electrons, protons or other charged ions for the purpose of generating a treatment beam. For example, the charged particles can be used either for generating white radiation or for directly irradiating a target object.

### BACKGROUND

The use of accelerators with dielectric walls or “dielectric wall accelerators” (DWA) is known for this purpose. Accelerators of this kind are typically coreless induction particle accelerators comprising a package that usually has a plurality of delay lines, wherein the functionality of said accelerators is based on different propagation times of electromagnetic waves in the delay lines. The fundamental principle of the propagation of an electromagnetic signal in a delay line is disclosed, for example, in U.S. Pat. No. 2,465,840 by A. D. Blumlein.

In an accelerator, current surges are introduced into the plurality of delay lines or time-delay lines. The geometric arrangement of delay lines and the electromagnetic waves that are generated by the current surges generate a time-variable magnetic field or a variation of the magnetic flux which, depending on the geometric arrangement of the delay lines, generates an accelerating electrical potential at a location, e.g. within a beam tube. The electrical potential is used for the purpose of accelerating charged particles.

A particle accelerator of said kind is known, for example, from U.S. Pat. No. 5,757,146. In this case a stack of disc-shaped capacitor pairs is used as a package of delay lines. In this arrangement a capacitor pair consists of two disc-shaped plate capacitors. The height of the plate capacitors and the dielectrics between the capacitor plates are selected such that an electromagnetic impulse wave in one capacitor of the capacitor pair propagates significantly faster than in the other capacitor. Such a capacitor pair is also referred to as an asymmetric Blumlein or Blumlein module in accordance with the delay lines disclosed by A. D. Blumlein.

In this case the stack of disc-shaped capacitor pairs or Blumlein modules is arranged around a central tube. Every second capacitor plate is at a positive potential relative to the other capacitor plates. In the static case, the capacitors alternately generate respectively opposing electrical fields which compensate for one another within the stack, i.e. along the central tube. If the capacitor plates are now short-circuited at the outer circumference, an electromagnetic impulse wave propagates radially inward between the capacitor plate pairs. Owing to the faster propagation speed of the inwardly directed impulse wave in every second capacitor, the impulse wave front in every second capacitor reaches the central tube at a time instant at which the impulse wave front in the other capacitors is still traveling inward and has not yet reached the central tube. This produces a combination of electromagnetic fields which generates an electrical potential for a certain time along the tube in the center of the stack. The potential that is generated by one capacitor pair ideally amounts to twice the charging voltage of the capacitor plates and exists until the slower impulse wave has likewise reached the central tube. This time period can be used for the purpose of accelerating charged particles along the tube. The impulse waves are reflected at the output of the delay line, i.e. at the inner tube in this case. This also occurs at different time instants due to the different propagation times.

The document titled “High electric field, high current packaging of SiC Photo-Switches”, Nunnally et al., discloses silicon carbide semiconductor switches which enable rapid closing of the switch on the basis of photo-induced discharge in semiconductors. A switch of said type also allows high current strengths, and in its open state it tolerates a high electrical field.

### SUMMARY

According to various embodiments, an accelerator can be provided which enables efficient operation and permits cost-effective manufacture. According to further embodiments, a method for operating an accelerator can be provided, which method allows efficient operation of an inexpensive accelerator.

According to an embodiment, an accelerator for accelerating charged particles may comprise at least two delay lines having different delays, the at least two delay lines having an input side into which electromagnetic waves can be introduced for the purpose of generating an accelerating electrical potential, wherein the input side of the delay lines is embodied to reflect electromagnetic waves, and wherein the accelerating electrical potential can be generated at least partly from waves that are reflected at the input side.

According to a further embodiment, the delay lines may have an output-side termination at an output side, said output-side termination having a higher resistance than an input-side termination at the input side. According to a further embodiment, a switching arrangement can be arranged at the input side, wherein said switching arrangement can be switched periodically. According to a further embodiment, the switching arrangement can be switched at a period that is coordinated with a propagation time of one of the delay lines. According to a further embodiment, the switching arrangement may have a two-way switch. According to a further embodiment, the switching arrangement can be embodied to introduce electromagnetic waves into the delay lines using a supply voltage, and wherein electromagnetic waves having a voltage amplitude that is greater than the supply voltage can be generated by way of resonant charging of the delay lines. According to a further embodiment, the accelerator may have a particle source with a pulsed operating mode, wherein a pulsed emission of particle bunches from the particle source is coordinated with the period of the switching arrangement.

According to another embodiment, in a method for operating an accelerator comprising at least two delay lines having different delays, the at least two delay lines have an input side into which electromagnetic waves are introduced for the purpose of generating an accelerating electrical potential, the electromagnetic waves which are introduced into the delay lines are reflected at the input side, and the accelerating electrical potential is generated at least partly from the waves which are reflected at the input side.

According to a further embodiment of the method, a switching arrangement can be arranged at the input side, wherein said switching arrangement is switched periodically, in particular at a period that is coordinated with a propagation time of one of the delay lines.

According to a further embodiment of the method, electromagnetic waves can be introduced into the delay lines by means of a supply voltage, and wherein electromagnetic waves having a voltage amplitude that is greater than the supply voltage are generated from the introduced electromagnetic waves by way of resonant charging of the delay lines. According to a further embodiment of the method, the accelerator may have a particle source which is operated in a pulsed operating mode, wherein a pulsed emission of particle bunches is coordinated in time with the period that is used for switching the switching arrangement.

### BRIEF DESCRIPTION OF THE DRAWINGS

Without limiting the scope of the invention thereto, embodiment variants of the invention and advantageous developments according to the features recited in the dependent claims will be explained in greater detail with reference to the following drawing, in which:

FIG. 1 shows an induction accelerator with delay lines having different delays, said delay lines being embodied as capacitors,

FIG. 2 shows a circuit diagram of a virtual circuit that is used for simulating the potential ratios,

FIG. 3 shows the time characteristic of the electrical potential that is generated by the fast time-delay line,

FIG. 4 shows the time characteristic of the electrical potential that is generated by the slow time-delay line, and

FIG. 5 shows the time characteristic of the accelerating total potential.

### DETAILED DESCRIPTION

The accelerator for accelerating charged particles according to various embodiments comprises at least two delay lines having different delays, wherein the at least two delay lines have an input side into which electromagnetic waves can be introduced, wherein an accelerating electrical potential can be generated at the output side with the aid of the waves. In this respect the accelerator is an induction accelerator. Furthermore, the input side of the delay lines is embodied to reflect electromagnetic waves, wherein the accelerating electrical potential at the output side can be generated at least partly by the reflected waves at the input side.

A wave that is introduced into one of the delay lines travels in the delay line and hits an output side at the end of the delay line. At said output side the wave is reflected and travels back to the input side again. Owing to the different delays in the two delay lines, a simultaneously introduced wave will be reflected earlier in one delay line than in the other delay line. The combination of electromagnetic waves generates an accelerating electrical potential at the output side for a certain time period, wherein said accelerating electrical potential is utilized for accelerating charged particles.

In this context a delay line is understood generally to mean a structure into which an electromagnetic wave can be introduced at an input side, wherein said electromagnetic wave travels to an output side. In particular, the delay line can have a capacitor-like structure with capacitor plates between which a dielectric is arranged. The capacitor-like structure can have e.g. a disc-type configuration, or also other configurations such as an elongated rectangle, a spiral wound elongated structure, etc. The accelerator will usually have a plurality of delay lines, these being utilized to generate the accelerating potential by taking advantage of the different delays.

According to various embodiments, advantage is now taken of the fact that a wave which has been reflected at the output side is now also reflected at the input side. The waves which are again reflected at the input side are now used for the purpose of contributing at least partly to the accelerating electrical potential. An electromagnetic wave that has been introduced is therefore reflected multiple times, both at the output side and at the input side, and consequently contributes periodically to the electrical potential.

The various embodiments are based on the insight that a number of advantages derive from utilizing an input-side reflection, particularly if the accelerator is to provide a large total potential of several hundred MV, e.g. 200 MV. For example, if the accelerator has a conductor stack of 2000 individual delay lines, 100 kV potential is required per delay line. Assuming a field wave impedance of 10 ohms, for example, it will be necessary to switch a current of 10 kA at the input side. This signifies an instantaneous power of 2 TW (=200 MV*10 kA). In addition, the switching times must be significantly shorter than the delay time of the time-delay line, this being e.g. 10 ns. Such requirements of a switch can only be satisfied with feasible overhead using e.g. complex silicon carbide semiconductor switches such as those disclosed in the document by Nunnally et al.

Although such switches have the advantage that they are closed in a triggered manner, they cannot be re-opened immediately. Re-opening is only possible after a comparatively long current zero. For the accelerator, however, this means that all of the energy stored in the delay lines (more than 10 kJ for the model calculation above) is only available for accelerating once, i.e. for several nanoseconds, and is then lost in an uncontrolled manner in the unavoidable dissipative resistances. A high level of energy consumption is therefore an obstacle to rapid pulse repetition.

Since the waves that are reflected at the input side are now also used for generating the potential, this allows the energy that is introduced into and stored in the delay line to be largely retained, such that considerably more pulses per second can be generated. Moreover, requirements in relation to the switching capacity for introducing electromagnetic waves can be drastically reduced, since—using the example of the model calculation above—only 1 kV now has to be switched instead of 100 kV, for example. However, such a switching capacity can also be handled using conventional inexpensive transistors which can be switched on and off quickly. This enables the waves to be caused to reflect at the input side in an effective manner, such that the pulse power is no longer lost at the input side.

In particular, the delay lines can be embodied in such a way that they have a termination at the output side, wherein said termination has a higher resistance than a termination of the delay line at the input side. For example, the delay line can be open or have a high impedance at the output side, while a low-impedance termination is provided at the input side.

At the input side, a switching arrangement for introducing waves can be provided which can be switched periodically, wherein control of the switching can be assumed by a control device. The period at which the switching arrangement is switched is coordinated with a propagation time of one of the delay lines. As a result of this it is possible to cause waves to reflect at the input side and simultaneously to feed energy into the delay line at suitable time instants. The switching arrangement can have a two-way switch for this purpose, e.g. a low-impedance two-way switch, which can easily be realized using transistors.

In particular, the switching arrangement can be embodied to introduce electromagnetic waves using a supply voltage, wherein electromagnetic waves having a voltage amplitude that is greater than the supply voltage are generated by resonant charging of the delay lines. It is thereby possible using a comparatively small supply voltage ultimately to generate a voltage amplitude that is a multiple of the supply voltage and allows a significant accelerating potential to be reached.

Staying with the calculation example above, the supply voltage can be e.g. 1 kV and gradually generate waves of 100 kV by means of resonant charging. The accelerator is therefore initially operated in a charging phase in which the waves having the required energy are gradually generated. At the end of the charging phase the switching arrangement must still switch the full current of 10 kA (=100 kV/10 ohms), but only at a voltage of 1 kV. At the end of the charging phase, i.e. after waves having the desired amplitude have been injected into the lines, the supply voltage can be reduced to the extent that the wave amplitude does not increase any further. In extreme cases the input can simply be short-circuited. If so desired, after acceleration of the particles has taken place, the voltage can be reduced by feeding the impulse wave energy back into the power supply unit. Alternatively, the impulse wave oscillations can also simply be allowed to decay.

The accelerator will usually have a particle source which is operated in a pulsed operating mode, such that particle bunches from the particle source are always emitted and provided whenever the accelerator—possibly after the charging phase—periodically has the appropriate electrical acceleration potential.

The method according to various embodiments provides for the operation of an accelerator that has at least two delay lines having an input side into which electromagnetic waves are introduced for the purpose of generating an accelerating electrical potential. In this case the accelerator is operated in such a way that the electromagnetic waves introduced into the delay lines are reflected at the input side, and that the accelerating electrical potential is generated at least partly from the waves that are reflected at the input side. In this way, by utilizing the waves that are reflected at the input side, the accelerator can be operated in a “quasi-periodic” mode.

Embodiments as described in relation to the accelerator can also be applied in the case of the embodiment of the method.

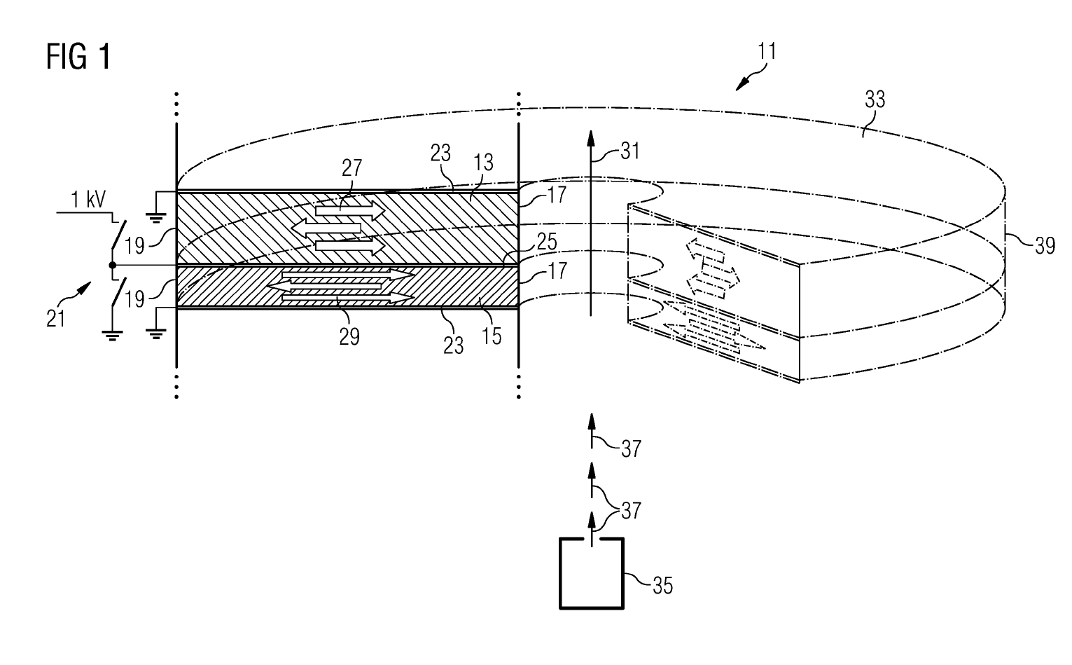

FIG. 1 schematically shows the structure of an induction accelerator 11. An important component of the accelerator 11 is a Blumlein module 39, by means of which an accelerating electrical potential can be generated along an acceleration direction 31. The accelerator 11 has a plurality of such Blumlein modules 39, only one Blumlein module 39 being schematically depicted for clarity of illustrated reasons.

In this arrangement the Blumlein module 39 comprises a fast delay line 15 and a slow delay line 13. The two delay lines 15, 13 are embodied as capacitors, the capacitor of the fast delay line 15 having a first dielectric with a first dielectric constant ∈₁, and the capacitor of the slow delay line having a second dielectric with a second dielectric constant ∈₂. The capacitor plates can be embodied e.g. in the form of a disc 33, though other geometric configurations are also conceivable. In this case, the height of the capacitors and the dielectric constants are selected such that an electromagnetic wave in the fast delay line 15 propagates considerably faster than in the slow delay line 13, this being symbolically represented by the thin arrows 29 and the thick arrows 27, respectively. A particularly favorable height ratio is given by a ratio of 1:√3, with a ratio between the dielectric constants ∈₁:∈₂ of 1:9. Impedance can be maximized using these parameters, thereby minimizing the currents required for switching. The propagation times of electromagnetic waves in the two delay lines 13, 15 can operate in the ratio of 1 to 3, for example.

The two outer capacitor plates 23 are grounded, while the central capacitor plate 25 can be set to a potential that is dependent on switching. Toward that end there is located at the input side 19 of the delay lines 13, 15—i.e. in this case at the outer circumference—a switching arrangement 21 which comprises a low-impedance two-way switch, and by means of which the central capacitor plate 25 can be fed with a supply voltage of 1 kV. If the potential of the central capacitor plate 25 at the outer circumference is initially set to 1 kV, for example, this generates an electromagnetic impulse wave which travels from the input side 19 radially inward to the output side 17. At the output side 17—i.e. at the inner circumference in this case—the impulse wave is reflected and travels back to the input side 19 again. In this case the switching arrangement 21 is periodically switched in such a way that the returning impulse wave is again reflected at the input side 19 and travels radially inward. By means of the switching arrangement 21 it is possible gradually to introduce further impulse waves into the delay lines 13, 15, said further impulse waves being superimposed on the impulse waves that are reflected back and forth, and generating an accelerating potential along an acceleration direction 31 in a periodic manner.

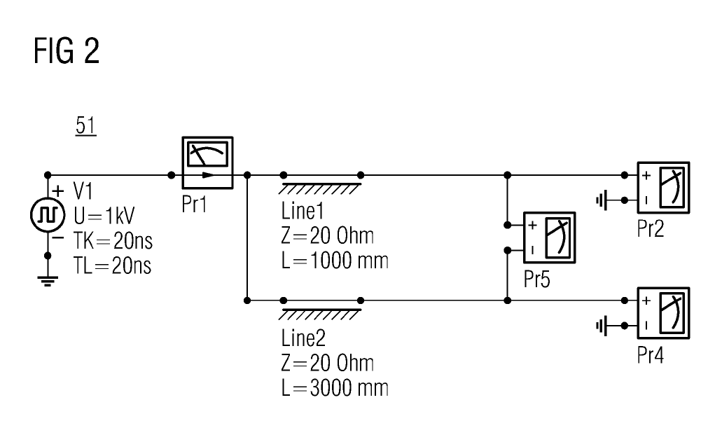

In this arrangement use is made of the different propagation times of the delay lines 13, 15. Given appropriate switching, the impulse waves that are present in the delay lines 13, 15 can charge in a resonant manner, with the result that gradually a comparatively strong electrical potential can be generated. This situation will be explained in greater detail below with reference to FIG. 2 to FIG. 5.

The induction accelerator 11 additionally has a particle source 35 which can be operated in a pulsed manner. Particle bunches 37 can therefore be emitted, the emission time instants being selected such that a particle bunch 37 enters the accelerator whenever an accelerating potential is present in the acceleration direction 31.

FIG. 2 shows the switching arrangement 51 by means of which the generation of the accelerating potential can be simulated. A first time-delay line is designated Line1 and has an electrical propagation-time length of L=1000 mm corresponding to 3.3 ns. A second time-delay line is designated Line2 and has an electrical propagation-time length of L=3000 mm corresponding to 10 ns, thereby mapping a ratio of 1 to 3 for the propagation times. The time-delay lines each have an impedance of Z=20 ohms, for example.

A rectangular alternating voltage V1 is applied to the input side of the time-delay lines, providing a supply voltage of U=1 kV. The switches are operated in such a way that they connect the central capacitor plates alternately for TK=TL=20 ns in each case with positive and negative potential, e.g. 1 kV and ground. A complete switching cycle therefore lasts 40 ns or 25 MHz.

The potential (Pr2) generated by the impulse waves that were introduced is tapped at the output of the first time-delay line. Similarly, the generated potential (Pr4) is tapped at the output of the second time-delay line. A difference in the two potentials (Pr5) is measured, the different polarity of the capacitor plates in a Blumlein module as shown in FIG. 1 being taken into account by forming the difference. The superimposition of the two potentials can be simulated thus.

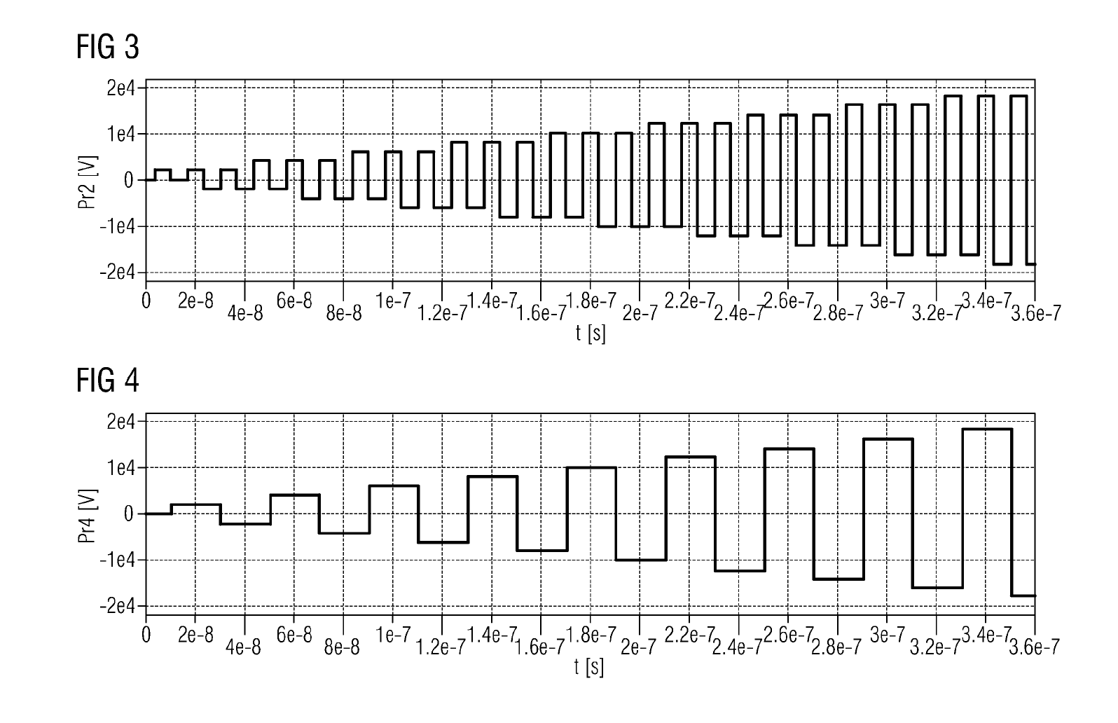

FIG. 3 shows the time characteristic of the potential (Pr2), in volts, that is generated at the output of the first time-delay line, while FIG. 4 shows the time characteristic of the potential (Pr4) that is generated at the output of the second time-delay line. Owing to the ratio of 1:3 for the propagation times, a potential change occurs three times more often at the output of the first time-delay line than at the output of the second time-delay line. The electromagnetic waves that are injected into a time-delay line are continuously reflected back and forth at both the output and the input in this case.

The rectangular alternating voltage V1 is periodically applied to the input of both time-delay lines, said period corresponding to the propagation time of an electromagnetic wave in the slower time-delay line.

Clearly to be seen in FIG. 3 and FIG. 4 are the voltage amplitudes of the electromagnetic wave in the time-delay lines, said wave becoming stronger over time (i.e. charging in a resonant manner).

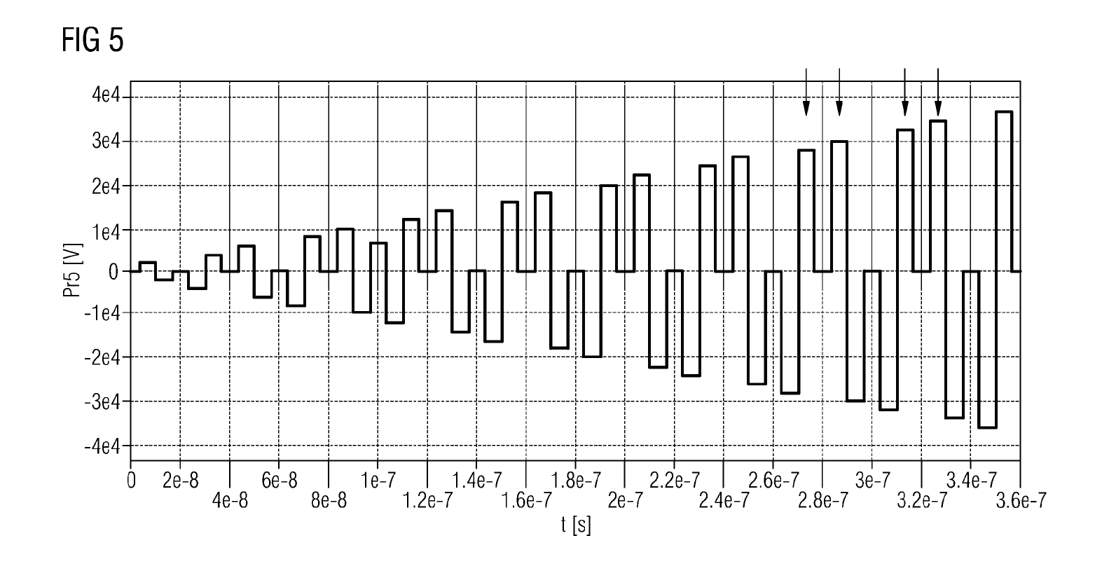

FIG. 5 shows a superimposition of the two potentials (Pr5) in volts. Whenever the two potentials are superimposed, such that the resulting potential is positive, this potential can be used to accelerate a particle bunch. Such time instants are symbolized in FIG. 5 by means of some arrows. A certain charging phase is usually required before the generated potential is great enough for the particle bunches entering the potential to be accelerated in the desired manner.

What is claimed is:

1. An accelerator for accelerating charged particles, comprising
at least two delay lines having different delays, the at least two delay lines having an input side into which electromagnetic waves can be introduced for the purpose of generating an accelerating electrical potential,
wherein the input side of the delay lines is embodied to reflect electromagnetic waves, and
wherein the accelerating electrical potential can be generated at least partly from waves that are reflected at the input side.

2. The accelerator according to claim 1, wherein
the delay lines have an output-side termination at an output side, said output-side termination having a higher resistance than an input-side termination at the input side.

3. The accelerator according to claim 1, wherein
a switching arrangement is arranged at the input side, wherein said switching arrangement can be switched periodically.

4. The accelerator according to claim 3, wherein
the switching arrangement can be switched at a period that is coordinated with a propagation time of one of the delay lines.

5. The accelerator according to claim 3, wherein
the switching arrangement has a two-way switch.

6. The accelerator according to claim 3, wherein
the switching arrangement is embodied to introduce electromagnetic waves into the delay lines using a supply voltage, and wherein electromagnetic waves having a voltage amplitude that is greater than the supply voltage can be generated by way of resonant charging of the delay lines.

7. The accelerator according to claim 3, wherein
the accelerator has a particle source with a pulsed operating mode, wherein a pulsed emission of particle bunches from the particle source is coordinated with the period of the switching arrangement.

8. A method for operating an accelerator comprising at least two delay lines having different delays, wherein the at least two delay lines have an input side into which electromagnetic waves are introduced for the purpose of generating an accelerating electrical potential,
the method comprising:
introducing the electromagnetic waves into the delay lines, wherein the electromagnetic waves are reflected at the input side, and generating the accelerating electrical potential at least partly from the waves which are reflected at the input side.

9. The method according to claim 8, wherein
a switching arrangement is arranged at the input side, the method further comprising: switching said switching arrangement periodically.

10. The method according to claim 8, comprising
introducing electromagnetic waves into the delay lines by means of a supply voltage, and generating electromagnetic waves having a voltage amplitude that is greater than the supply voltage from the introduced electromagnetic waves by way of resonant charging of the delay lines.

11. The method according to claim 8, wherein
the accelerator has a particle source which is operated in a pulsed operating mode, the method comprising: coordinating a pulsed emission of particle bunches in time with the period that is used for switching the switching arrangement.

12. The method according to claim 8, wherein
a switching arrangement is arranged at the input side, the method further comprising: switching said switching arrangement periodically at a period that is coordinated with a propagation time of one of the delay lines.

13. The method according to claim 8, wherein
the delay lines have an output-side termination at an output side, said output-side termination having a higher resistance than an input-side termination at the input side.

14. The method according to claim 8, wherein the switching arrangement has a two-way switch.

15. A method for accelerating charged particles, comprising:
providing at least two delay lines having different delays, the at least two delay lines having an input side into which electromagnetic waves can be introduced for the purpose of generating an accelerating electrical potential, wherein the input side of the delay lines is embodied to reflect electromagnetic waves, and
generating the accelerating electrical potential at least partly from waves that are reflected at the input side.

16. The method according to claim 15, wherein
the delay lines have an output-side termination at an output side, said output-side termination having a higher resistance than an input-side termination at the input side.

17. The method according to claim 15, comprising:
arranging a switching arrangement at the input side and switching said switching arrangement periodically.

18. The method according to claim 17, comprising switching the switching arrangement at a period that is coordinated with a propagation time of one of the delay lines.

19. The method according to claim 17, wherein
the switching arrangement is embodied to introduce electromagnetic waves into the delay lines using a supply voltage, and the method comprising: generating electromagnetic waves having a voltage amplitude that is greater than the supply voltage by way of resonant charging of the delay lines.

20. The method according to claim 17, wherein
the accelerator has a particle source with a pulsed operating mode, and the method comprises coordinating a pulsed emission of particle bunches from the particle source with the period of the switching arrangement.
